(19) United States
(12) Patent Application Publication
(10) Pub. No.: US 2018/0121567 A1
(43) Pub. Date: May 3, 2018

(54) TECHNOLOGIES FOR LOCATION-BASED VISUALIZATION OF SOCIAL DATA

(71) Applicant: Spatial Labs, LLC, Cincinnati, OH (US)

(72) Inventors: Lyden Lorrie Foust, Cincinnati, OH (US); William Theodore Kiessling, Cincinnati, OH (US)

(21) Appl. No.: 15/799,702

(22) Filed: Oct. 31, 2017

Related U.S. Application Data
(60) Provisional application No. 62/414,856, filed on Oct. 31, 2016.

(51) Int. Cl. G06F 17/30

(52) U.S. Cl. CPC G06F 17/30991; G06F 17/30241; G06F 17/30867; G06F 17/30994

(57) ABSTRACT

A location-based social data visualization system a system for generating a graphical visualization of social data for a geographical region includes a social data visualization (SDV) server 110 communicatively coupled to one or more social media sources 140 via one or more communication networks 150.

### REFERENCE TO RELATED APPLICATION

This application claims priority to U.S. provisional patent application Ser. No. 62/414,856, filed Oct. 31, 2016, which is hereby incorporated by reference in its entirety.

### TECHNICAL FIELD

Embodiments of the technologies described herein relate, in general, to collecting and analyzing social data for a geographical region. More particularly, the technologies described herein relate to an electronic platform for collecting geotagged social media content and generating a graphical visualization representative of a city or a geographical region therefrom.

### BRIEF DESCRIPTION OF THE DRAWINGS

It is believed that certain embodiments will be better understood from the following description taken in conjunction with the accompanying drawings, in which like references indicate similar elements and in which:

FIG. 1 is a simplified block diagram of at least one embodiment of a system for generating a graphical visualization of social media data for a geographical region;

FIG. 2 is a simplified flow diagram of at least one embodiment of a method that may be executed by the social data visualization server of FIG. 1 for collecting geotagged social media data and generating a graphical visualization thereof;

FIG. 3 is a simplified flow diagram of at least one other embodiment of a method that may be executed by the social data visualization server of FIG. 1 for collecting geotagged social media data and generating a graphical visualization thereof;

FIG. 4 is an illustrative embodiment of a category identification table that may be used by the social data visualization server of FIG. 1 to match social media content to reference keywords and thereby identify one or more associated categories;

FIG. 5 is an illustrative embodiment of another category identification table that may be used by the social data visualization server of FIG. 1 to match social media content to reference keywords and thereby identify one or more associated categories; and

FIG. 6 is an illustrative interface generated by the social data visualization server of FIG. 1 including a graphical visualization of the social media data for a geographical region.

### DETAILED DESCRIPTION

Various non-limiting embodiments of the present disclosure will now be described to provide an overall understanding of the principles of the structure, function, and use of systems and methods disclosed herein. One or more examples of these non-limiting embodiments are illustrated in the selected examples disclosed and described in detail with reference made to the figures in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. In addition, elements illustrated in the figures are not necessarily drawn to scale for simplicity and clarity of illustration. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware.

The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

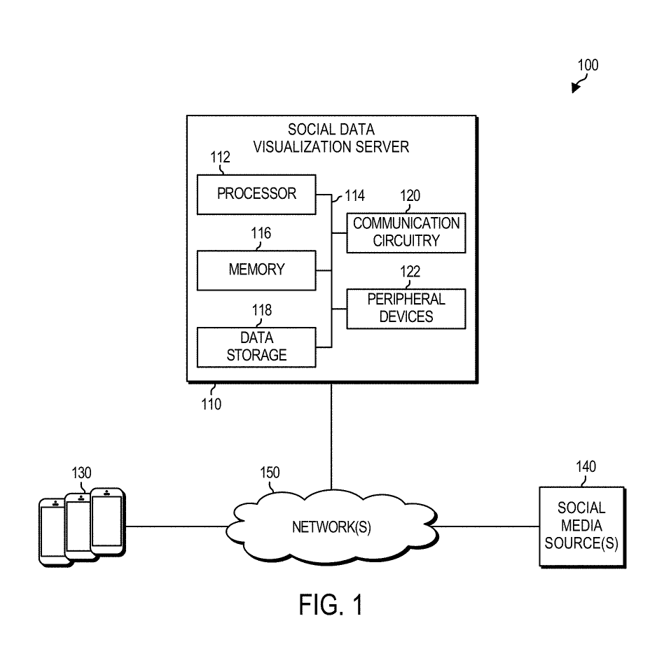

Referring now to FIG. 1, in one embodiment, a system 100 for generating a graphical visualization of social data for a geographical region includes a social data visualization (SDV) server 110 communicatively coupled to one or more social media sources 140 via one or more communication networks 150. In some embodiments, the SDV server 110 can be embodied as a stand-alone computing device. In other embodiments, the SDV server 110 can be embodied as a cloud-based service configured to provide the functionality described herein.

In operation, social data indicative or representative of a geographical region is collected by the SDV server 110. In the illustrative embodiment, the social data may be geotagged social media content (e.g., posts, short messages, comments, “likes,” “check-ins,” status information, reviews, location data, etc.) generated by one or more users for distribution via the social media source(s) 140. The social media content can be generated by the users via various types of mobile computing devices 130 (e.g., smartphones, tablet computers, laptop computers, smartwatches, wearable computing devices, smart glass devices, etc.). In the illustrative embodiment, the social media content generated by the users describes a place, an event or, more generally, a “vibe” within a geographical region such as, for example, a city, a neighborhood, a district, a state, a country, or any other type of geographical region. For example, in some embodiments, the social media content may be a particular user's social media post pertaining to a concert or other form of event (e.g., parade, festival, sale, tour, rally, etc.) at which the user is currently attending. In another example, the social media content may be another user's check-in at a restaurant or a retail establishment. In yet another example, the social media content may be a user's comments regarding their experiences or actions at a particular location. It should be appreciated that the social media content can be any other type of content or data generated by a user that describes, or is representative of, a “vibe,” “feeling,” or perception of the user with respect to a geographical region (or a portion thereof). To facilitate geographical analysis and graphical visualization, the social media content is geotagged (e.g., latitude, longitude, etc.) by the mobile computing device(s) 130 and/or the social media source(s) 140 when generated and/or received.

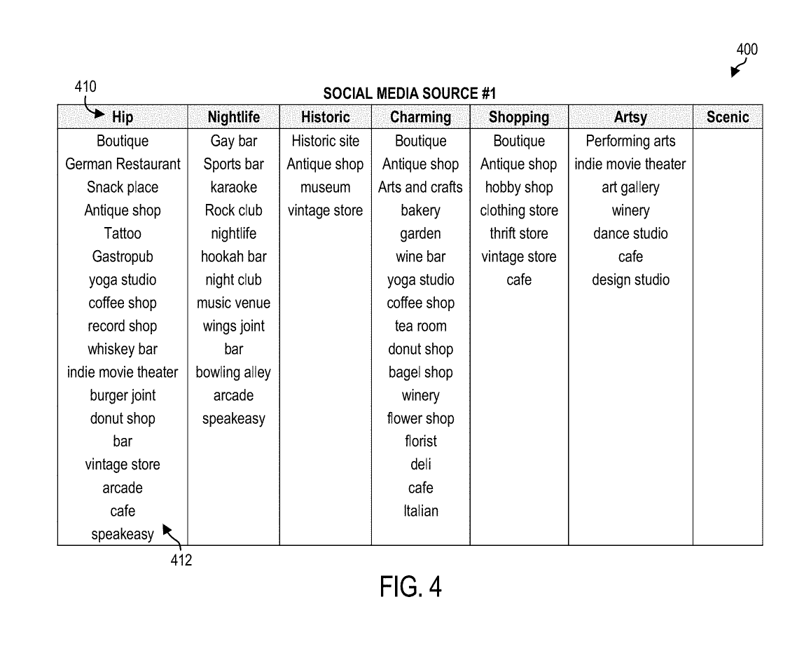

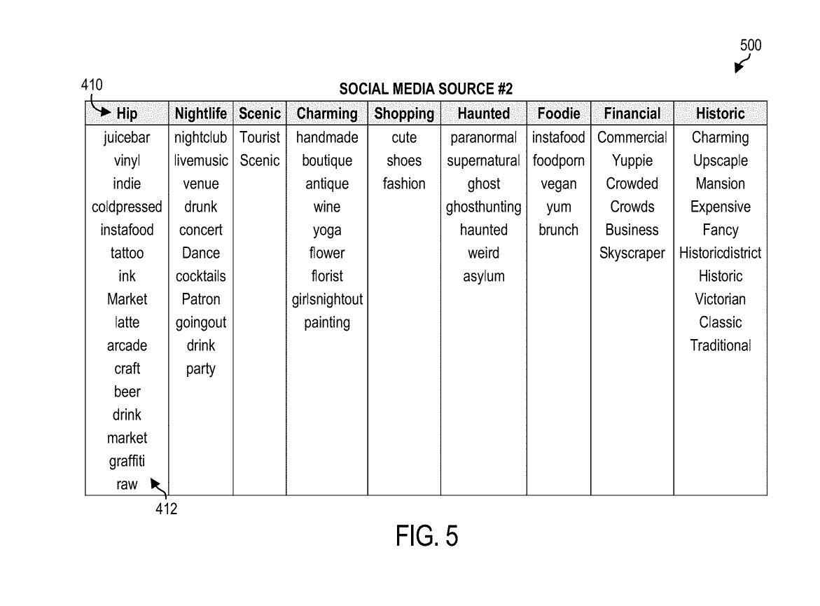

In the illustrative embodiment, the SDV server 110 collects the geotagged social media data/content from social media source(s) 140 for a defined geographical region. Thereafter, the SDV server 110 parses the collected geotagged social media data to identify the textual content thereof. Each geotagged social media data item collected is then categorized by the SDV server 110 using its corresponding textual content. To do so, in some embodiments, the SDV server 110 compares the textual content of each geotagged social media data item collected to one or more category identification tables such as, for example, the category identification tables 400, 500 shown in FIGS. 4 and 5. As illustratively shown, the category identification tables 400, 500 include various categories 410 that describe or are representative of different “vibes” or “feelings.” Each of the categories 410 can include one or more keywords 412 or terms associated therewith. Referring back to FIG. 1, in the illustrative embodiment, the SDV server 110 can determine whether the textual content associated with a particular geotagged social media data item matches one or more of the keywords 412 of the category identification tables 400, 500. If the SDV server 110 determines that the textual content matches one or more of the keywords 412, the SDV server 110 can identify the particular category 410 (or categories 410 if multiple keywords are matched) to be assigned to the particular item of social media. The SDV server 110 can perform a similar process for each of the social media data items collected.

The SDV server 110 can subsequently group the social media data item within a particular category based on proximity. For example, the SDV server 110 may determine that two (or more) geotagged social media items within a particular category (e.g., “HIP”) were generated in close proximity to each other based on latitude and longitude information (or any other type of location data) included therewith. In such example, the SDV server 110 may group those geotagged social media items in to a first group (e.g., “GROUP 1”). Continuing with the same example, the SDV server 110 may also determine that a different geotagged social media item within the same category (e.g., “HIP”) is not in close proximity to the other two geotagged social media items based on the latitude and longitude information included therewith. In making such determination, the SDV server 110 may group the different geotagged social media item into a second group (e.g., “GROUP 2”). Such groupings can be used to facilitate graphical visualization of different “hotspots” within a particular category (e.g., “HIP”) of a particular geographical region.

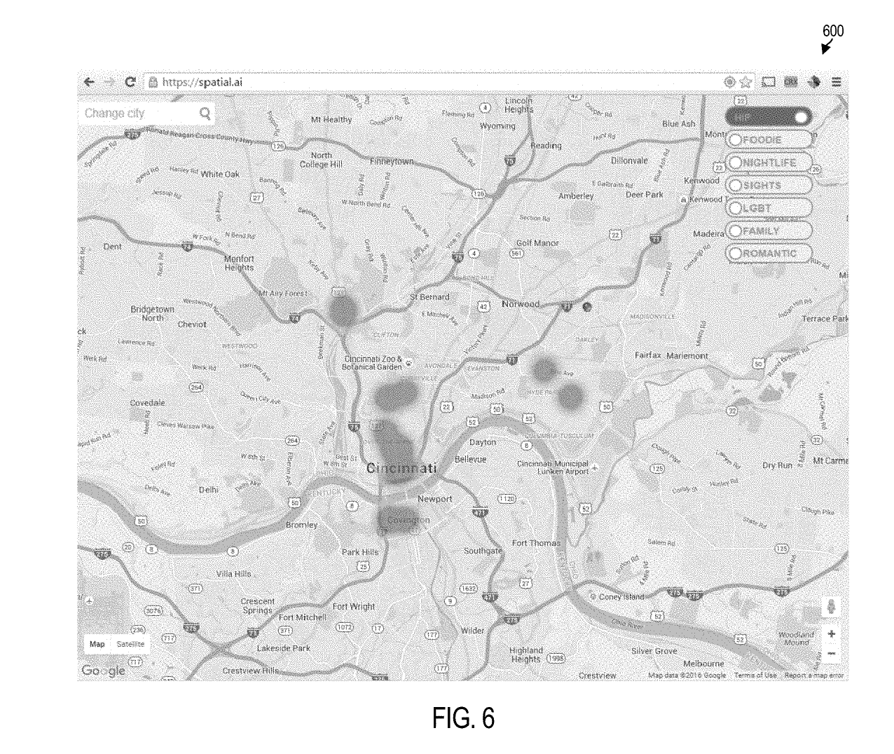

After grouping the categorized social media data items, the SDV server 110 generates a graphical visualization of the data. Such visualization can graphically depict portions of a geographical region that, based on the information derived from the social media data items, have a particular “vibe” or “feeling.” It should be appreciated that such “vibes” or “feelings” can correspond to the categories of the category identification tables 400, 500. In some embodiments, the graphical visualization generated by the SDV server 110 can be embodied as one or more “hotspots” or color-coded objects presented via an information layer of an electronic map (e.g., the electronic map 600 and information layer illustratively shown in FIG. 6).

The SDV server 110 can be embodied as any type of computing device or server capable of processing, communicating, storing, maintaining, and transferring data. For example, the SDV server 110 can be embodied as a server, a microcomputer, a minicomputer, a mainframe, a desktop computer, a laptop computer, a mobile computing device, a handheld computer, a smart phone, a tablet computer, a personal digital assistant, a telephony device, a custom chip, an embedded processing device, or other computing device and/or suitable programmable device. In some embodiments, the SDV server 110 can be embodied as a computing device integrated with other systems or subsystems. In the illustrative embodiment of FIG. 1, the SDV server 110 includes a processor 112, a system bus 114, a memory 116, a data storage 118, communication circuitry 120, and one or more peripheral devices 122. Of course, the SDV server 110 can include other or additional components, such as those commonly found in a server and/or computer (e.g., various input/output devices), in other embodiments. Additionally, in some embodiments, one or more of the illustrative components can be incorporated in, or otherwise from a portion of, another component. For example, the memory 116, or portions thereof, can be incorporated in the processor 112 in some embodiments. Furthermore, it should be appreciated that the SDV server 110 can include other components, sub-components, and devices commonly found in a computer and/or computing device, which are not illustrated in FIG. 1 for clarity of the description.

The processor 112 can be embodied as any type of processor capable of performing the functions described herein. For example, the processor 112 can be embodied as a single or multi-core processor, a digital signal processor, a microcontroller, a general purpose central processing unit (CPU), a reduced instruction set computer (RISC) processor, a processor having a pipeline, a complex instruction set computer (CISC) processor, an application specific integrated circuit (ASIC), a programmable logic device (PLD), a field programmable gate array (FPGA), or any other type of processor or processing/controlling circuit or controller.

In various configurations, the SDV server 110 includes a system bus 114 for interconnecting the various components of the SDV server 110. The system bus 114 can be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations with the processor 112, the memory 116, and other components of the SDV server 110. In some embodiments, the SDV server 110 can be integrated into one or more chips such as a programmable logic device or an application specific integrated circuit (ASIC). In such embodiments, the system bus 114 can form a portion of a system-on-a-chip (SoC) and be incorporated, along with the processor 112, the memory 116, and other components of the SDV server 110, on a single integrated circuit chip.

The memory 116 can be embodied as any type of volatile or non-volatile memory or data storage capable of performing the functions described herein. For example, the memory 116 can be embodied as read only memory (ROM), random access memory (RAM), cache memory associated with the processor 112, or other memories such as dynamic RAM (DRAM), static RAM (SRAM), programmable ROM (PROM), electrically erasable PROM (EEPROM), flash memory, a removable memory card or disk, a solid state drive, and so forth. In operation, the memory 116 can store various data and software used during operation of the SDV server 110 such as operating systems, applications, programs, libraries, and drivers.

The data storage 118 can be embodied as any type of device or devices configured for short-term or long-term storage of data such as, for example, memory devices and circuits, memory cards, hard disk drives, solid-state drives, or other data storage devices. For example, in some embodiments, the data storage 118 includes storage media such as a storage device that can be configured to have multiple modules, such as magnetic disk drives, floppy drives, tape drives, hard drives, optical drives and media, magneto-optical drives and media, Compact Disc (CD) drives, Compact Disc Read Only Memory (CD-ROM), Compact Disc Recordable (CD-R), Compact Disc Rewriteable (CD-RW), a suitable type of Digital Versatile Disc (DVD) or Blu-Ray disc, and so forth. Storage media such as flash drives, solid state hard drives, redundant array of individual disks (RAID), virtual drives, networked drives and other memory means including storage media on the processor 112, or the memory 116 are also contemplated as storage devices. It should be appreciated that such memory can be internal or external with respect to operation of the disclosed embodiments. It should also be appreciated that certain portions of the processes described herein can be performed using instructions stored on a computer-readable medium or media that direct or otherwise instruct a computer system to perform the process steps. Non-transitory computer-readable media, as used herein, comprises all computer-readable media except for transitory, propagating signals.

The communication circuitry 120 of the SDV server 110 may be embodied as any type of communication circuit, device, interface, or collection thereof, capable of enabling communications between the SDV server 110 and the social media source(s) 140, the mobile computing device(s) 130, and/or any other computing devices communicatively coupled thereto. For example, the communication circuitry 120 may be embodied as one or more network interface controllers (NICs), in some embodiments. The communication circuitry 120 may be configured to use any one or more communication technologies (e.g., wireless or wired communications) and associated protocols (e.g., Ethernet, WiMAX, etc.) to effect such communication.

In some embodiments, the SDV server 110, the social media source(s) 140, the mobile computing device(s) 130, and/or any other computing devices of the system 100, can communicate with each other over one or more networks 150. The network(s) 150 can be embodied as any number of various wired and/or wireless communication networks. For example, the network(s) 150 can be embodied as or otherwise include a local area network (LAN), a wide area network (WAN), a cellular network, or a publicly-accessible, global network such as the Internet. Additionally, the network(s) 150 can include any number of additional devices to facilitate communication between the computing devices of the system 100.

Additionally, in some embodiments, the SDV server 110 can further include one or more peripheral devices 122. Such peripheral devices 122 can include any type of peripheral device commonly found in a computing device such as additional data storage, speakers, a hardware keyboard, a keypad, a gesture or graphical input device, a motion input device, a touchscreen interface, one or more displays, an audio unit, a voice recognition unit, a vibratory device, a computer mouse, a peripheral communication device, and any other suitable user interface, input/output device, and/or other peripheral device.

The social media source(s) 140 can be embodied as any type of social media provider or platform that provides electronic services (e.g., social networking, online reviews, online chatting, etc.) over a network to the users and/or the mobile computing devices 130 of the users. As such, the social media source(s) 140 include computing devices and infrastructures commonly found in social media source(s) 140, which are not shown in FIG. 1 for clarity of the description. In the illustrative embodiment, the social media source(s) 140 are configured to communicate with the mobile computing devices 130 of the users and the SDV server 110 over the network(s) 150.

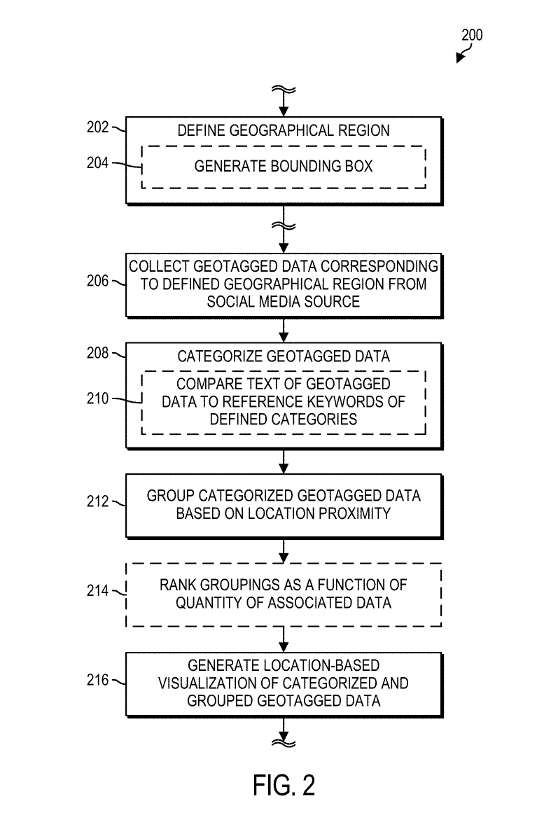

Referring now to FIG. 2, a method 200 that may be executed by the SDV server 110 for collecting geotagged social media data and generating a graphical visualization thereof begins with block 202. In block 202, the SDV server 110 defines a geographical region (e.g., a city, neighborhood, district, state, country, etc.) of interest. In some embodiments, in block 204, the SDV server 110 generates a bounding box to define the geographical area. In such embodiments, the bounding box can be generated using one or more coordinates (e.g., latitude, longitude, etc.) received or previously defined by a user or system administrator.

In block 206, the SDV server 110 collects geotagged social media data/content from one or more social media sources 140 for the defined geographical region. The geotagged social media content may be any type of social media content (e.g., posts, short messages, comments, “likes,” “check-ins,” status information, reviews, location data, etc.) generated by one or more users for distribution via the social media source(s) 140. In an illustrative embodiment, the geotagged social media content includes one or more types of location metadata (e.g., latitude, longitude, elevation, etc.) to facilitate subsequent geographical analysis and graphical visualization. The location metadata of the geotagged social media content can be generated by the mobile computing devices 130 of the users when such content is created. Additionally or alternatively, the location metadata can be generated by the social media source(s) 140 when the content is received.

In block 208, the SDV server 110 categorizes each of the geotagged social media content items collected from the social media source(s) 140. For example, the SDV server 110 may categorize a particular item of geotagged social media content as “HIP” or “ARTSY.” It should be appreciated that the SDV server 110 can also categorize the geotagged social media content items into any number of different categories. To do so, in some embodiments, the SDV server 110, in block 210, compares the textual content of each geotagged social media data item collected to one or more category identification tables 400, 500.

In block 212, the SDV server 110 groups the social media content items within a particular category based on proximity. To do so, the SDV server 110 may analyze the location metadata of each of the social media content items within a particular category and determine whether any are within a reference distance threshold of each other. In embodiments in which the SDV server 110 determines that two or more social media content items are in close proximity to each other, the SDV server 110 may group those social media content items into the same group (e.g., a first group). It should be appreciated that in some embodiments the SDV server 110 may associate a group identifier (e.g., “GROUP 1,” “1,” “A,” etc.) with each of the social media content items determined to be in close proximity to each other. Additionally, in such embodiments, the remaining social media content items (e.g., those which are not in close proximity to the first group) can be grouped together into one or more different groups (e.g., a second group, a third group, etc.).

In some embodiments, in block 214, the SDV server 110 ranks the groups as a function of the quantity of data associated therewith. That is, the SDV server 110 may assign a rank to each group based on the number of social media content items included within each group. It should be appreciated that the SDV server 110 can use any suitable process or technique for assigning a ranking to each of the groups.

In block 216, the SDV server 110 generates a graphical visualization of the social media content items. Such graphical visualization can depict portions of a geographical region that, based on the information derived from the social media content items, have a particular “vibe” or “feeling.” It should be appreciated that such “vibes” or “feelings” can correspond to the categories of the category identification tables 400, 500. In some embodiments, the graphical visualization generated by the SDV server 110 can be embodied as one or more “hotspots” or color-coded objects presented via an information layer of an electronic map (e.g., the electronic map 600 and information layer illustratively shown in FIG. 6).

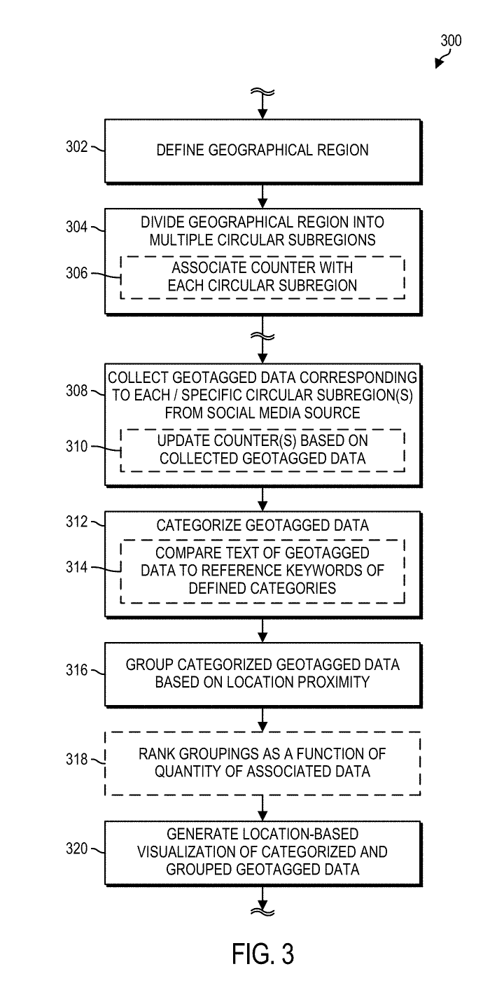

Referring now to FIG. 3, another method 300 that may also be executed by the SDV server 110 for collecting geotagged social media data and generating a graphical visualization thereof begins with block 302. In block 302, the SDV server 110 defines a geographical region (e.g., a city, neighborhood, district, state, country, etc.) of interest. In bloc 304, the SDV server 110 divides the geographical region into multiple circular subregions. In some embodiments, the SDV server 110 may define each circular subregion by using coordinate information (e.g., latitude and longitude) and a reference radius distance. Additionally, in some embodiments, in block 306, the SDV server 110 can associate a counter with each circular subregion. Such counters can be used to track how often a particular circular subregion should be checked for the existence of new social media content items. In such embodiments, the counter of a particular circular subregion may be incremented based on the number of social media content items received within a reference period of time. It should be appreciated that the counters can be increased or decreased by the SDV server 110 according to any other suitable tracking process or technique.

In block 308, the SDV server 110 collects geotagged social media data/content from one or more social media sources 140 for each of the defined circular subregions. In embodiments in which counters are used, the SDV server 110 may, in block 310, update the counters based on the collected geotagged social media content.

In block 312, the SDV server 110 categorizes each of the geotagged social media content items collected from the social media source(s) 140. To do so, in some embodiments, the SDV server 110, in block 314, compares the textual content of each geotagged social media data item collected to one or more category identification tables 400, 500. In block 316, the SDV server 110 groups the social media content items within a particular category based on proximity. In some embodiments, in block 318, the SDV server 110 ranks the groups as a function of the quantity of data associated therewith.

In block 320, the SDV server 110 generates a graphical visualization of the social media content items. Such graphical visualization can depict portions of a geographical region that, based on the information derived from the social media content items, have a particular “vibe” or “feeling.” It should be appreciated that such “vibes” or “feelings” can correspond to the categories of the category identification tables 400, 500. In some embodiments, the graphical visualization generated by the SDV server 110 can be embodied as one or more “hotspots” or color-coded objects presented via an information layer of an electronic map (e.g., the electronic map 600 and information layer illustratively shown in FIG. 6).

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

1. A location-based social data visualization apparatus according to one or more of the inventive principles as shown and described herein.

2. A location-based social data visualization system according to one or more of the inventive principles as shown and described herein.

3. A method for generating a graphical visualization of social data corresponding to a geographical area according to one or more of the inventive principles as shown and described herein.
